(19) United States
(12) Patent Application Publication
(10) Pub. No.: US 2016/0371653 A1
(43) Pub. Date: Dec. 22, 2016

(54) CAPTURING TRANSACTIONAL INFORMATION THROUGH A CALENDAR VISUALIZATION

(71) Applicant: Microsoft Technology Licensing, LLC, Redmond, WA (US)

(72) Inventors: Kyle S. Young, Duvall, WA (US); Janeth Guerrero Gomez, Duvall, WA (US)

(21) Appl. No.: 14/744,234

(22) Filed: Jun. 19, 2015

(51) Int. Cl. G06Q 10/10; G06F 17/30; G06F 3/0484

(52) U.S. Cl. CPC G06Q 10/1093; G06F 3/04842; G06F 17/30342

(57) ABSTRACT

A category selection is detected and subcategories corresponding to the category are identified. A calendar display is surfaced that includes data capturing mechanisms. User interaction with the data capturing mechanisms is detected and data is captured. The calendar display is then updated.

### BACKGROUND

Computing systems are currently in wide use. Some computing systems are deployed at organizations and perform a wide variety of processing tasks that assist the organization in performing operations.

Some such computing systems detect user interactions and capture information based on the detected interaction. The information can include transactional information related to a given user, a given event, etc.

Capturing this type of transactional data is often done by detecting user interactions with a table or grid that has corresponding dates and categories associated therewith. This has often meant that a user, in order to enter data, must provide a variety of different user inputs. The user inputs can include a time user input selecting a time period, a category input selecting a category, and a wide variety of other information. This can be cumbersome and error prone.

The discussion above is merely provided for general background information and is not intended to be used as an aid in determining the scope of the claimed subject matter.

### SUMMARY

A category selection is detected and subcategories corresponding to the category are identified. A calendar display is surfaced that includes data capturing mechanisms. User interaction with the data capturing mechanisms is detected and data is captured. The calendar display is then updated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIGS. 2A and 2B (collectively referred to herein as FIG. 2) show a flow diagram illustrating one example of the operation of the architecture shown in FIG. 1 in capturing data.

FIGS. 3-5 are examples of user interface displays.

FIG. 6 is a block diagram of another example of a computing system architecture.

FIG. 7 is a block diagram of the architectures shown in the previous figures, deployed in a cloud computing architecture.

FIGS. 8-10 show examples of mobile devices that can be used in the architectures shown in the previous figures.

FIG. 11 is a block diagram of one example of a computing environment that can be used in the architectures shown in the previous figures.

### DETAILED DESCRIPTION

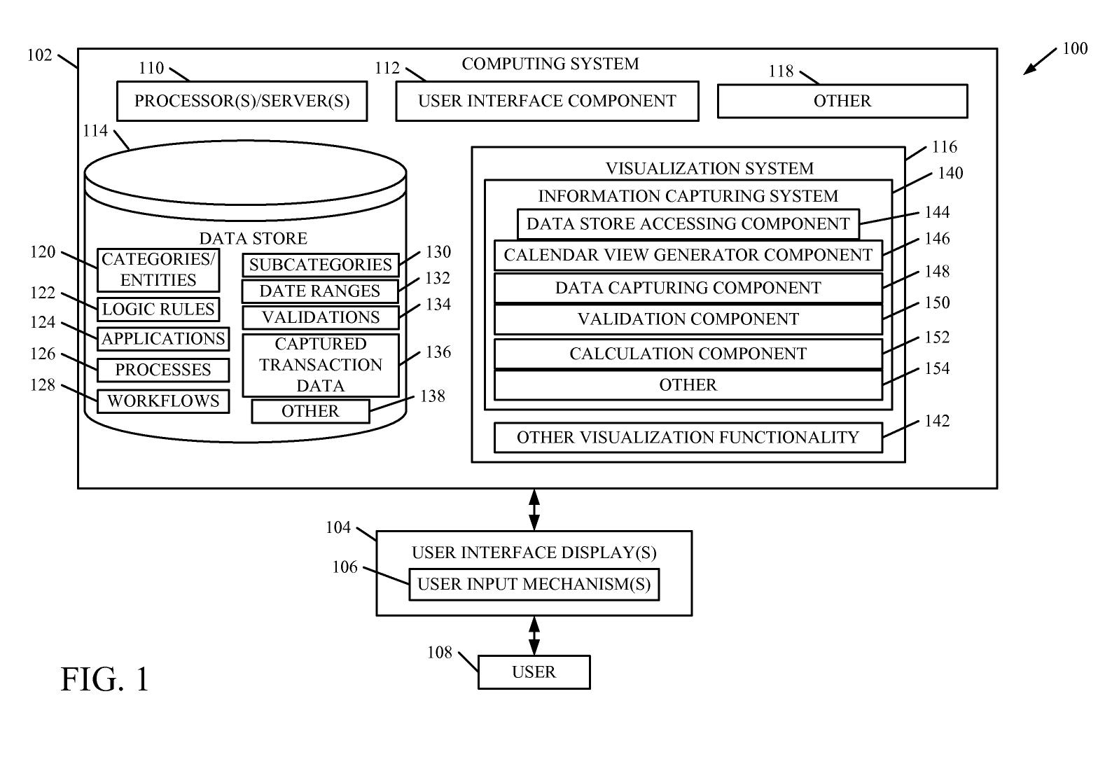

FIG. 1 is a block diagram of one example of a computing system architecture 100. Architecture 100 includes computing system 102 that generates user interface displays 104, with user input mechanisms 106, for interaction by user 108. User 108 illustratively interacts with user input mechanisms 106 in order to control and manipulate computing system 102.

In the example shown in FIG. 1, computing system 102 illustratively includes one or more processors or servers 110, user interface component 112, data store 114, visualization system 116, and it can include other items 118. Data store 114 can include a set of categories or entities 120, logic rules 122, applications 124, processes 126, workflows 128, subcategories 130, date ranges 132, validations 134, captured transaction data 136, and it can include other items 138. Processors or servers 110 can illustratively run applications 124 which execute logic rules 122 and perform processes 126 and workflows 128. The applications 124 can operate on categories or entities 120 which, themselves, illustratively represent items within computing system 102. For instance, a “customer” entity represents a customer. An “invoice” entity represents an invoice. An “expense” entity represents an expense, etc. This is only a small example of the different types of categories or entities 120 that can be stored in data store 114.

As is described in greater detail below, the various categories or entities can have subcategories 130 and can be associated with date ranges 132 and a set of validations 134. Users 108 can input transaction data 136, that is captured by computing system 102.

Visualization system 116 illustratively includes information capturing system 140 and other visualization functionality 142. Information capturing system 140, itself, illustratively includes data store accessing component 144, calendar view generator component 146, data capturing component 148, validation component 150, calculation component 152, and it can include other items 154. Visualization system 116 controls user interface component 112 to generate various visualizations, with data capturing user input mechanisms that can be actuated by user 108 so that system 102 can capture transaction data from user 108. As is described in greater below, user 108 can specify a category 120 for which data is to be captured. Data store accessing component 144 accesses data store 114 to identify any subcategories 130, date ranges 132 or validations 134 (as well as any logic rules 122) that are associated with the identified category. Calendar view generator component 146 then generates a calendar view with data capturing user input mechanisms. Data capturing component 148 detects user interaction with those user input mechanisms and captures the corresponding data. In doing so, validation component 150 and calculation component 152 can enforce any validations 134 associated with the category or subcategories, and perform any calculations identified by logic rules 122, or otherwise. Calendar view generator component 146 then updates the calendar view visualization to reflect the captured data. The captured data can eventually be saved as captured transaction data 136 to data store 114.

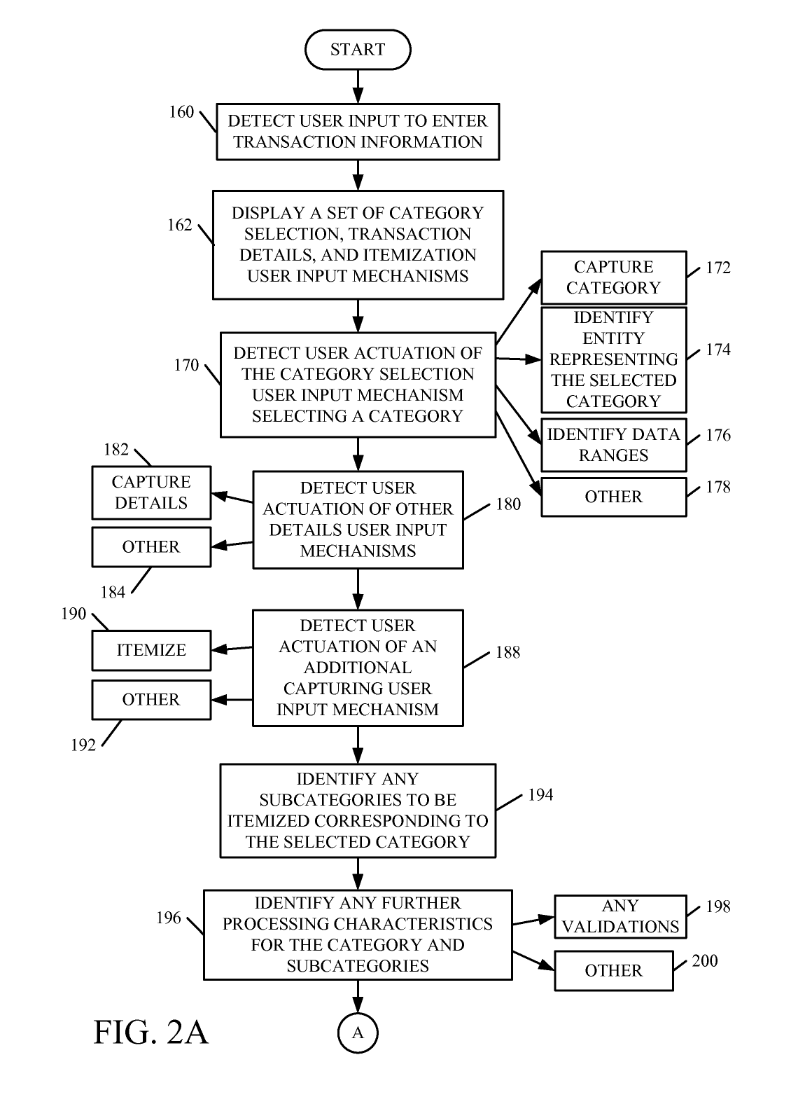

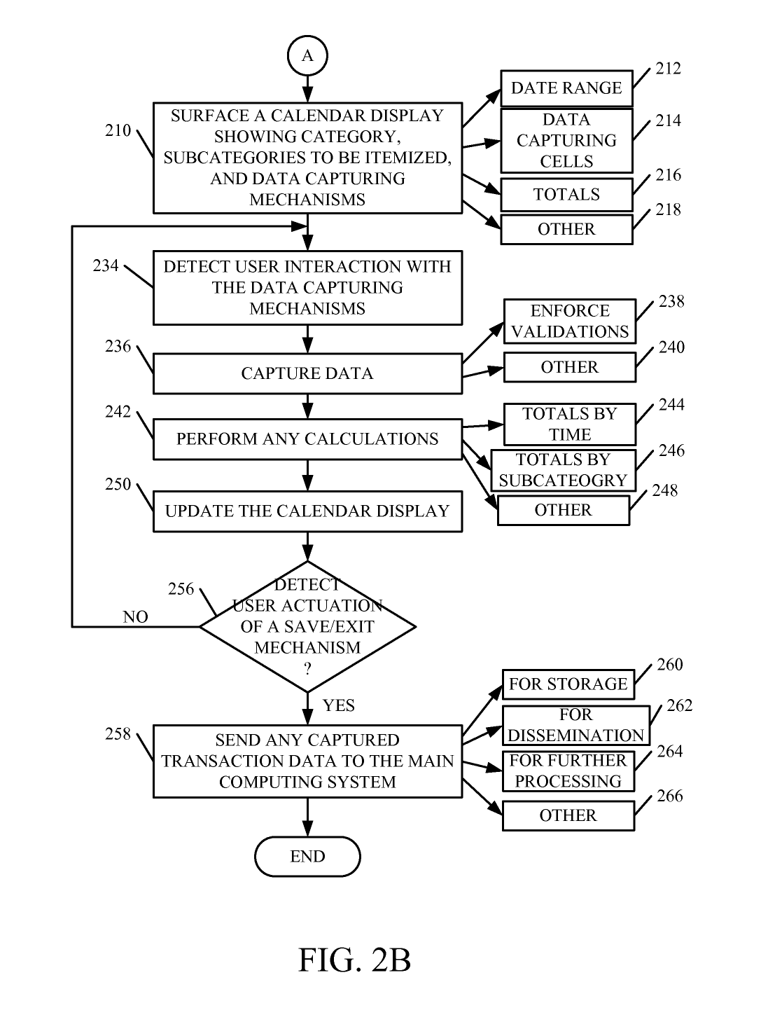

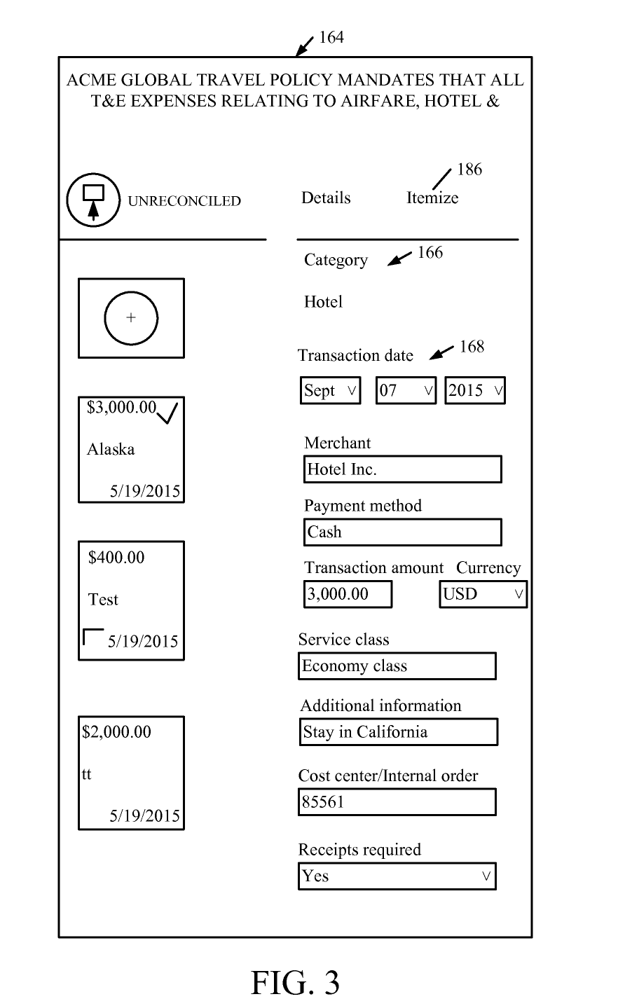

FIGS. 2A and 2B (collectively referred to herein as FIG. 2) show a flow diagram illustrating one example of the operation of architecture 100 in capturing data, in more detail. FIGS. 3-5 show examples of user interface displays that can be generated by visualization system 116. FIGS. 1-5 will now be described in conjunction with one another.

User 108 illustratively accesses computing system 102, such as by providing authentication information, login information, or otherwise. User 108 eventually provides a user input indicating that the user wishes to enter transaction information. For example, user 108 can actuate a user input mechanism 106 to indicate this. User interface component 112 detects the user input indicating that the user wishes to enter transaction information. This is indicated by block 160 in FIG. 2.

In response, visualization system 116 illustratively controls user interface component 112 to display a user interface display with a set of category selection, transaction details, and itemization user input mechanisms. This is indicated by block 162. FIG. 3 shows one example of a user interface display 164 that indicates this. It can be seen in FIG. 3 that display 164 illustratively includes a category selection user input mechanism 166 as well as a set of transaction details user input mechanisms 168, and an itemization user input mechanism. Category selection user input mechanism 166 is illustratively a user actuatable mechanism which, when actuated by the user, allows the user to specify or select a particular category for which transaction data is to be entered. This can be done using a suitable user input mechanism, such as a drop down menu or another mechanism. The transaction details user input mechanisms can include a date mechanism that allows the user to enter or select a date, a merchant mechanism that allows the user to enter or select a merchant, a payment mechanism that allows the user to enter or select a payment method, amount and currency indicators that allow the user to enter or select an amount and a currency, and a variety of other mechanisms that allow the user to enter other transaction details.

It can be seen in FIG. 3 that the user has selected the “hotel” category using category selection user input mechanism 166. Detecting user actuation of the category selection user input mechanism, in order to select the category, is indicated by block 170 in the flow diagram of FIG. 2.

In response, data capturing component 148 (in FIG. 1) captures the category information as indicated by block 172. Data store accessing component 144 can then access data store 114 to identify an entity within computing system 102 that represents the selected category, if any. This is indicated by block 174. It may also identify date ranges 132 associated with the selected category, and automatically populate the transaction details user input mechanism that allows the user to specify date. This is indicated by block 176. It can of course detect user actuation of the category selection user input mechanism 166 in other ways as well, and this is indicated by block 178.

Data capturing component 148 also illustratively detects user actuation of the other details user input mechanisms 168 and captures those details. This is indicated by blocks 180 and 182. It can capture details in other ways as well, and this is indicated by block 184.

At some point, user 108 may wish to enter additional itemization information corresponding to the transaction information. The user can provide a suitable user input to indicate this. For instance, in the example shown in FIG. 3, user interface display 164 includes “itemize” user input mechanism 186. When the user actuates this mechanism 186, calendar view generator component 146 illustratively generates a calendar view that allows the user to further itemize the transaction information. Detecting user actuation of a capturing user input mechanism (such as itemize mechanism 186) is indicated by blocks 188 and 190 in FIG. 2. The user can actuate another capturing user input mechanisms as well, to itemize transaction data, and this is indicated by block 192.

By actuating the itemize user input mechanism 186, this indicates that user 108 wishes to itemize the transaction information (such as the payment amount) in various subcategories. In addition, it may be that computing system 102 enforces a restraint that certain transaction information is to be itemized. In either case, once the user actuates the itemize user input mechanism 186, data store accessing component 144 illustratively accesses data store 114 to identify any subcategories that are to be itemized and that correspond to the selected category. This can be done by examining metadata, mappings, or in other ways. This is indicated by block 194 in FIG. 2.

Data store accessing component 144 can also illustratively identify any further processing characteristics for the category and subcategories. This is indicated by block 196. For instance, component 144 may identify that there are certain validations 134 that are to be enforced during itemization of the transactional information in the category and subcategories. This is indicated by block 198. It may also identify that certain calculations (e.g., based on logic rules 122) are to be performed for the itemized information. It can identify further processing characteristics in other ways as well, and this is indicated by block 200.

Calendar view generator component 146 then surfaces a calendar display showing the category, and subcategories into which the transactional data is to be itemized, along with data capturing mechanisms on the calendar display. This is indicated by block 210. The calendar display can display data capturing mechanisms for date ranges 212, it can display the data capturing mechanisms as editable cells 214, it can use logic rules to calculate totals 216, and it can display a wide variety of other information 218.

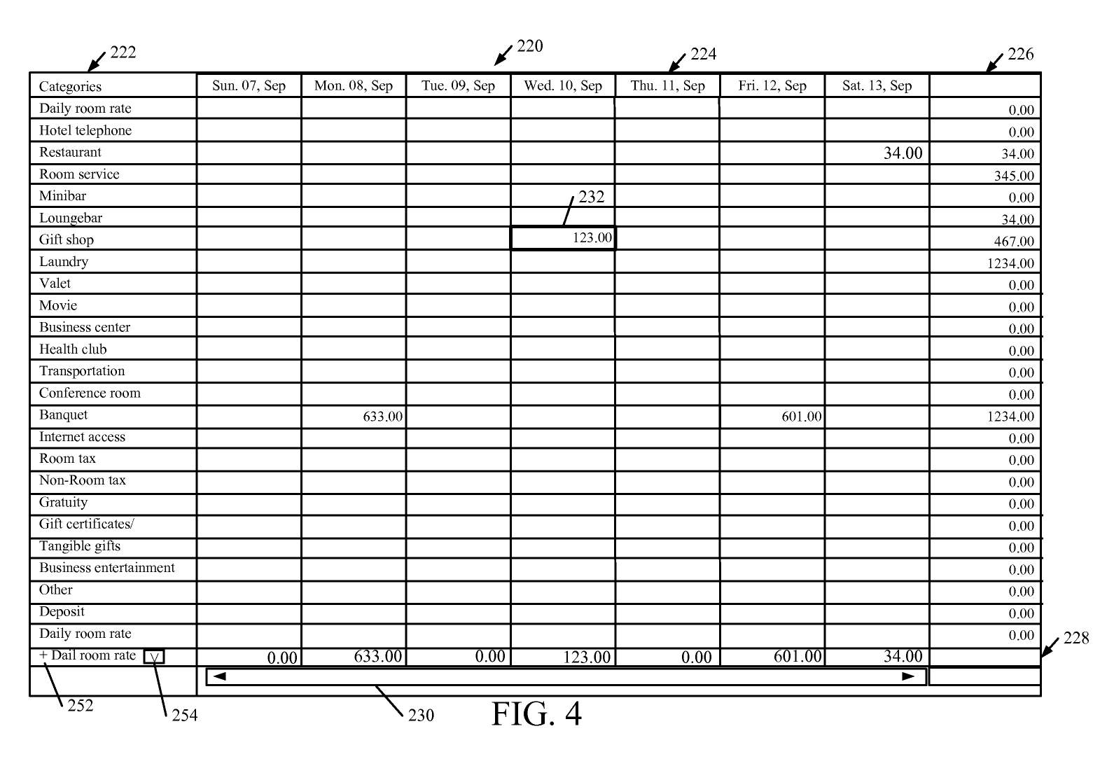

FIG. 4 shows one example of a user interface display 220 that illustrates this. It can be seen that user interface display 220 includes a subcategories column 222 that lists all of the subcategories that are associated with the “hotel” category within data store 114 of computing system 102. They include such things as the daily room rate, hotel telephone charges, restaurant charges, room service charges, etc. User interface display 220 also displays, across the top of the display, a date range row that identifies time periods (which can be individual dates or sets of dates, like “6-8-14”, or “the week of 6-8-14”, etc.) in a set of columns 224 corresponding to a date range. It can be seen that the date range associated with this particular “hotel” category is September 7-September 13. The date range may be dynamically computed or it may be fixed, based upon the particular category selected. In addition, if the date range exceeds the display space, it can continue off the page and the user can scroll through it. For instance, when the user checked into a hotel, the user may have created the “hotel” entity and identified the dates of the user's stay at the hotel. From that information, the date range 224 can automatically be identified. Then, when the user selects the hotel category and identifies a hotel, the corresponding date range can be identified by data store accessing component 144 so calendar view generator component 146 can use that date range in surfacing the calendar view. Alternatively, of course, the user 108 can enter the date range on the details page shown in FIG. 3. The date range can be identified in other ways as well.

User interface display 220 also illustratively includes a subcategory total column 226 and a date total row 228. The subcategory total column 226 includes the total of all amounts entered in each subcategory across the entire date range 224. The date total row 228 totals all of the amounts entered on each given day. It can also be seen that user interface display 220 includes scroll bar 230. Therefore, the cells corresponding to dates not shown can be seen by scrolling scroll bar 230 to the right or left on the page of FIG. 4.

User 108 can enter transaction information by highlighting or selecting a given cell. It can be seen in FIG. 4 that cell 232 has been selected by the user. The cell then becomes editable so that the user can enter transaction information in that cell. It can be seen in FIG. 4 that the user has entered $123 as an amount corresponding to the gift shop subcategory and the amount was incurred on September 10. Detecting user interaction with the data capturing user input mechanisms is indicated by block 234 in FIG. 2.

Data capturing component 148 then captures the transactional data entered by the user. This is indicated by block 236. In one example, validation component 150 illustratively enforces any validations corresponding to the category or subcategories, as the user is entering data. This is indicated by block 238. For instance, it may be that a validation precludes a user from entering an expense on a future date. Thus, if the user scrolls to a future date and attempts to enter expense data, validation component 150 illustratively generates an error or other violation message indicating that the user is attempting to enter an expense on a future date, which is prohibited. A wide variety of different validations can be enforced. Data capturing component 148 can capture data in other ways as well, and this is indicated by block 240.

Also, in one example, calculation component 152 performs any calculations that are to be performed on the captured data. This is indicated by block 242. For instance, it may be that the calculations are to calculate a total for each time interval. This is indicated by block 244. As seen in FIG. 4, the time total row 228 displays totals for each day. In another example, calculation component 152 illustratively calculates totals on a per subcategory basis. This can be seen in FIG. 4 in the totals column 226. Calculating totals on a per subcategory basis is indicated by block 246. A wide variety of other calculations can be performed as well, and this is indicated by block 248.

As system 102 is capturing transaction data, and as the various validations and calculations are being enforced and performed, respectively, calendar view generator component 146 illustratively updates the calendar visualization accordingly. This is indicated by block 250 in FIG. 2. For instance, as the user enters data, the totals can be updated.

It will be noted that other user interactions can be performed as well. For instance, the user can actuate the addition user input mechanism 252 or drop down mechanism 254. Actuating these mechanisms allows the user to add a sub category to column 222. Actuating mechanism 254 displays a drop down menu of various sub categories that can be added (and it can include a text box for the user to enter a new sub category), and actuating the addition user input mechanism 252 adds the selected subcategory to the display 220.

At some point, the user will either exit or save the information that has been captured. This is indicated by block 256 in FIG. 2. Until that time, processing reverts to block 234 where additional transaction information can be captured, based upon the user interactions with the user input mechanisms.

When the user exits or saves the transaction information, then any captured transaction data can be sent to the main computing system 102. This is indicated by block 258. It can be sent for storage in data store 114, as captured transaction data 136. This is indicated by block 260. It can be sent for dissemination to other users as indicated by block 262. For instance, if the user submits an expense report, it may be disseminated for the user's manager to approve. It can be submitted for further processing (such as aggregation in another visualizations that can be generated for user 108, or a different user) or other further processing as indicated by block 264. It can be captured and sent to the main computing system in other ways as well, and this is indicated by block 266.

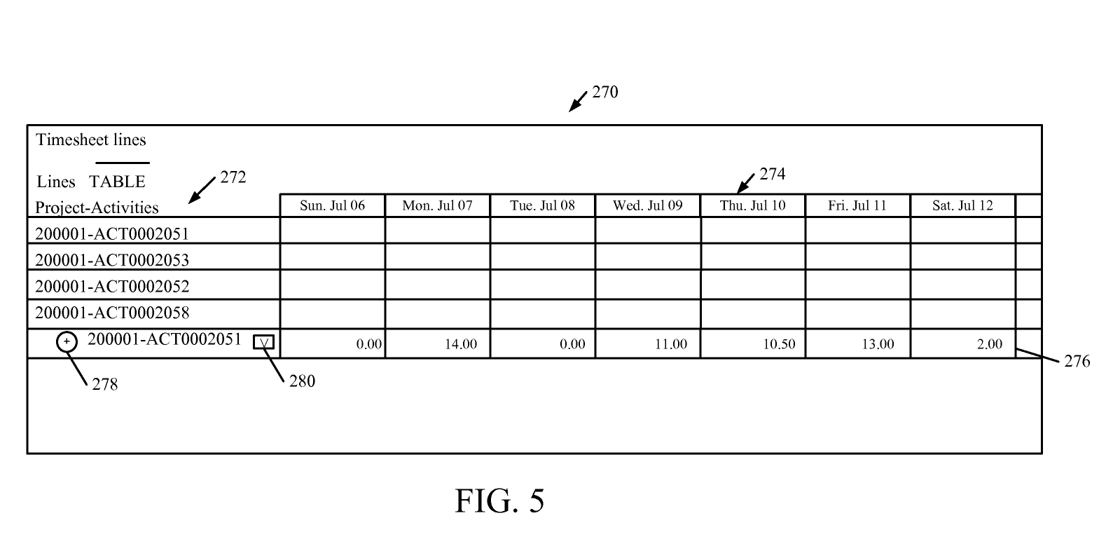

FIG. 5 shows another example of a user interface display 270 that can be generated by calendar view generator component 146, when the user wishes to itemize transaction data. FIG. 5 shows that, instead of expense transaction data, the user input mechanisms in FIG. 5 collect timesheet transaction data. Thus, user 108 may be associated with a plurality of different projects in computing system 102. In the example shown in FIG. 5, the expense sheet calendar view includes a project column 272 that lists all of the projects that the user is associated with. It also includes a date range 274 that associates columns with individual days. It includes a total row 276 that totals the amount entered on each of the days, over all of the projects in project column 272. It includes an addition user input mechanism 278 and a drop down mechanism 280. The user can actuate mechanism 280 to select another project to be added to display 270, and the user can actuate addition mechanism 278 to add the selected project. Again, as the user enters time amounts within the cells in display 270, data capturing component 148 captures that data and validation component 150 and calculation component 152 perform validations and calculations on the captured data. Calendar view generator component 146 updates the calendar view based on those validations and calculations, and based on the captured data.

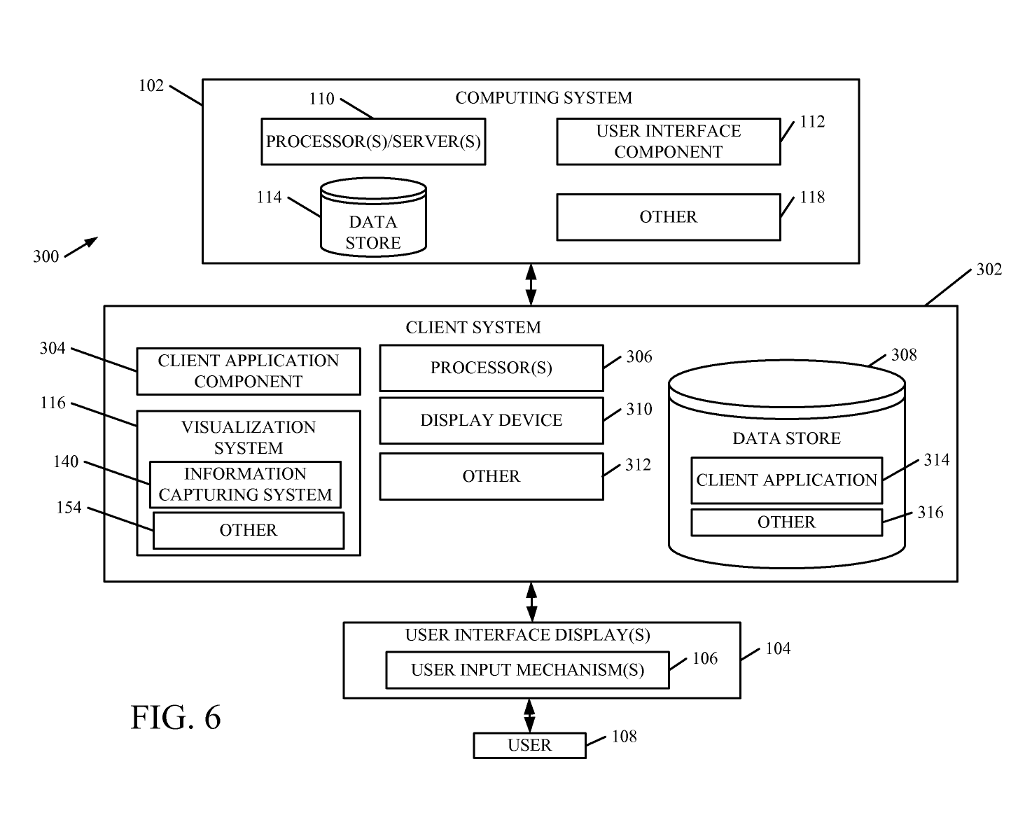

FIG. 6 shows one example of a block diagram of a different computing system architecture 300. Some items are similar to those shown in FIG. 1 and they are similarly numbered. Architecture 300 includes computing system 102 which has servers or processors 110, user interface component 112, other items 118, and data store 114. However, FIG. 6 shows that computing system 102 now communicates with a client system 302. Client system 302, itself, illustratively includes a client application component 304 that runs a client application that communicates with computing system 102. Client system 302 also illustratively includes one or more processors 306, visualization system 116 which includes information capturing system 140 and other items 154, along with data store 308, display device 310, and other items 312. Data store 308 can illustratively include a client application 314 that is run by client application component 304. It can include other data items 316 as well. Visualization system 116 illustratively generates user interface displays 104 with user input mechanisms 106 for interaction by user 108. It can thus be seen that some of the items in FIG. 6 are similar to those shown in FIG. 1. However, the visualization system 116 is now deployed on client computing system 302, instead of the main computing system 102.

It can thus be seen that the present system advantageously surfaces a calendar display for capturing itemized transaction data. A category is selected, and a set of subcategories, and possibly date ranges, are automatically and dynamically populated for user interaction. This significantly improves the processing of the computing system itself. Normally, the user would need to perform multiple user input operations to enter this type of information. This can increase the processing overhead and memory requirements of the system. In addition, the present system improves the accuracy with which the transaction data is captured. The visualization allows the user 108 to easily see whether a date is incorrect, or whether certain transaction data has been erroneously omitted, simply by viewing the date ranges and whether information has been captured for those ranges. All of this improves the accuracy of the system as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

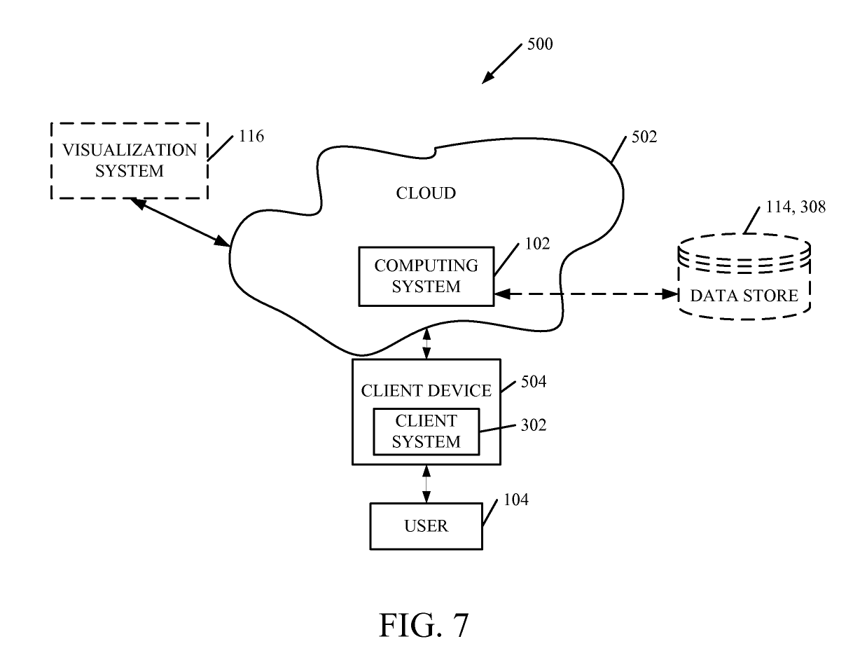

FIG. 7 is a block diagram of architectures 100 or 300, shown in FIGS. 1 and 6, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architectures 100 or 300 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 7, some items are similar to those shown in FIGS. 1 and 6 and they are similarly numbered. FIG. 7 specifically shows that computing system 102 can be located in cloud 502 (which can be public, private, or a combination where portions are public while others are private). Therefore, user 104 uses a client device 504 that includes system 302 to access system 102 through cloud 502.

FIG. 7 also depicts another example of a cloud architecture. FIG. 7 shows that it is also contemplated that some elements of architectures 100 or 300 can be disposed in cloud 502 while others are not. By way of example, data stores 114, 308 can be disposed outside of cloud 502, and accessed through cloud 502. In another example, visualization system 116 can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architectures 100 or 300, or portions of then, can be disposed on a wide variety of different devices. Some of those devices include servers, desktop computers, laptop computers, tablet computers, or other mobile devices, such as palm top computers, cell phones, smart phones, multimedia players, personal digital assistants, etc.

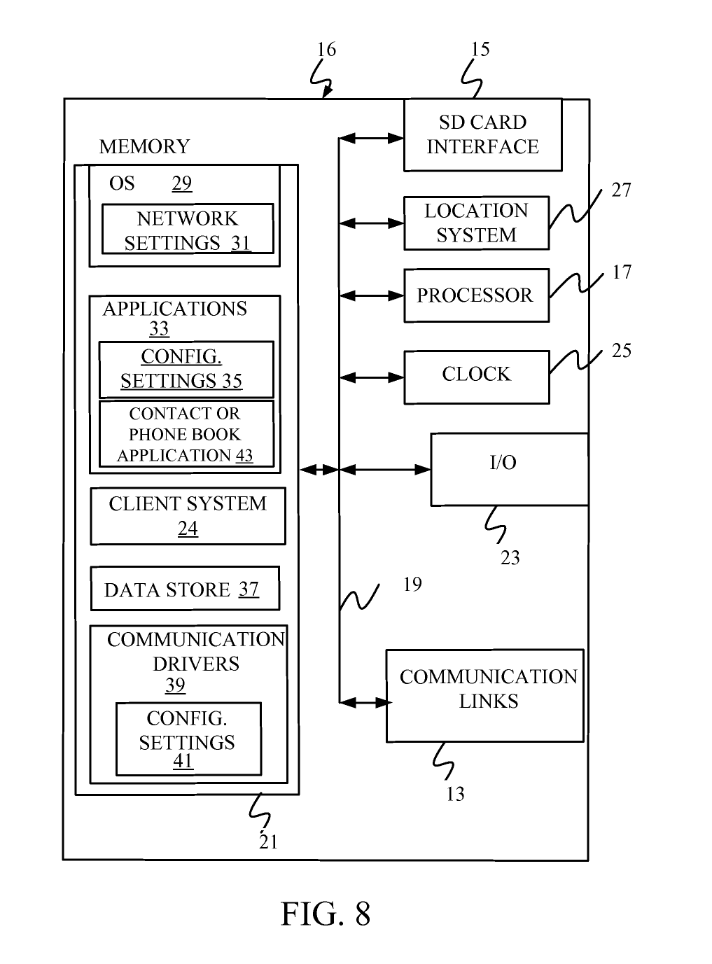

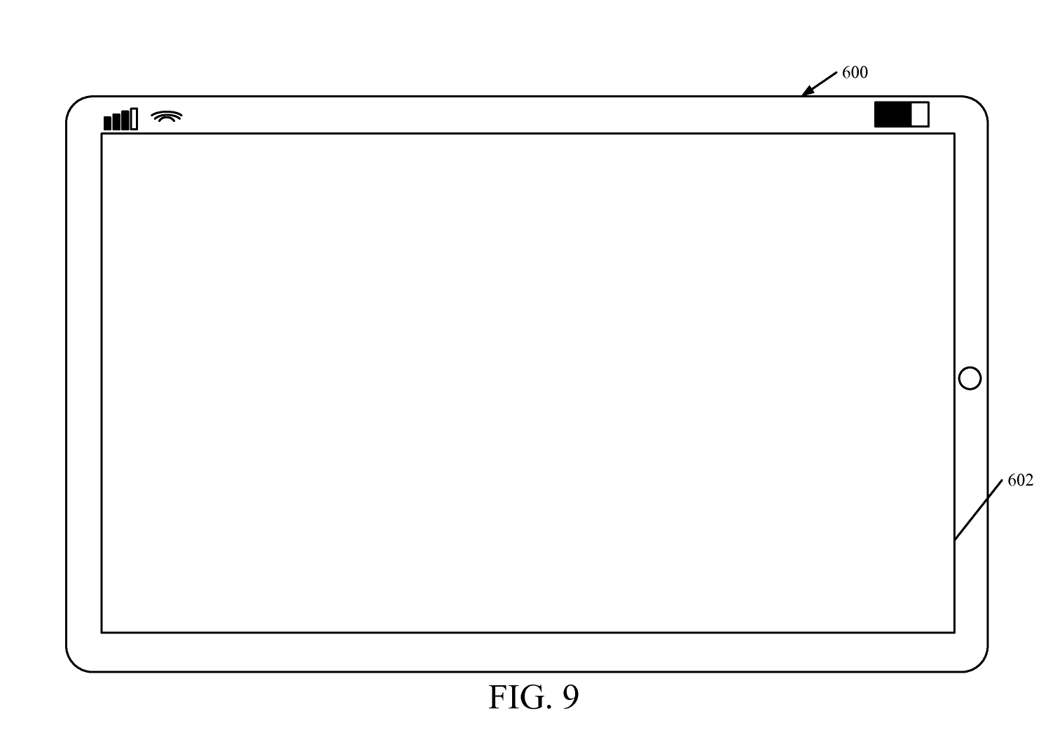

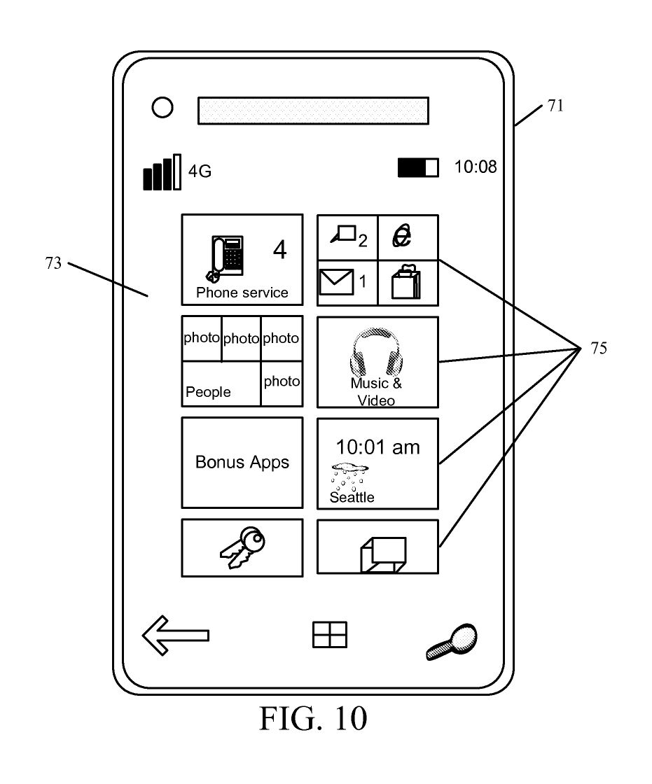

FIG. 8 is a simplified block diagram of one illustrative example of a handheld or mobile computing device that can be used as a user's or client's hand held device 16, in which the present system (or parts of it) can be deployed. FIGS. 9-10 are examples of handheld or mobile devices.

FIG. 8 provides a general block diagram of the components of a client device 16 that can run components of architectures 100 or 300 or that interacts with architectures 100 or 300, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

In other example, applications or systems are received on a removable Secure Digital (SD) card that is connected to a SD card interface 15. SD card interface 15 and communication links 13 communicate with a processor 17 (which can also embody processors or servers 110 or 306 from FIG. 1) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Application 154 or the items in data store 156, for example, can reside in memory 21. Similarly, device 16 can have a client business system 24 which can run various business applications or embody parts or all of tenant 104. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 9 shows one example in which device 16 is a tablet computer 600. In FIG. 9, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used as well. Device 16 can be, a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some examples the phone also includes a Secure Digital (SD) card slot that accepts a SD card.

The mobile device can also be a personal digital assistant or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can also include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 10 shows that the phone can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

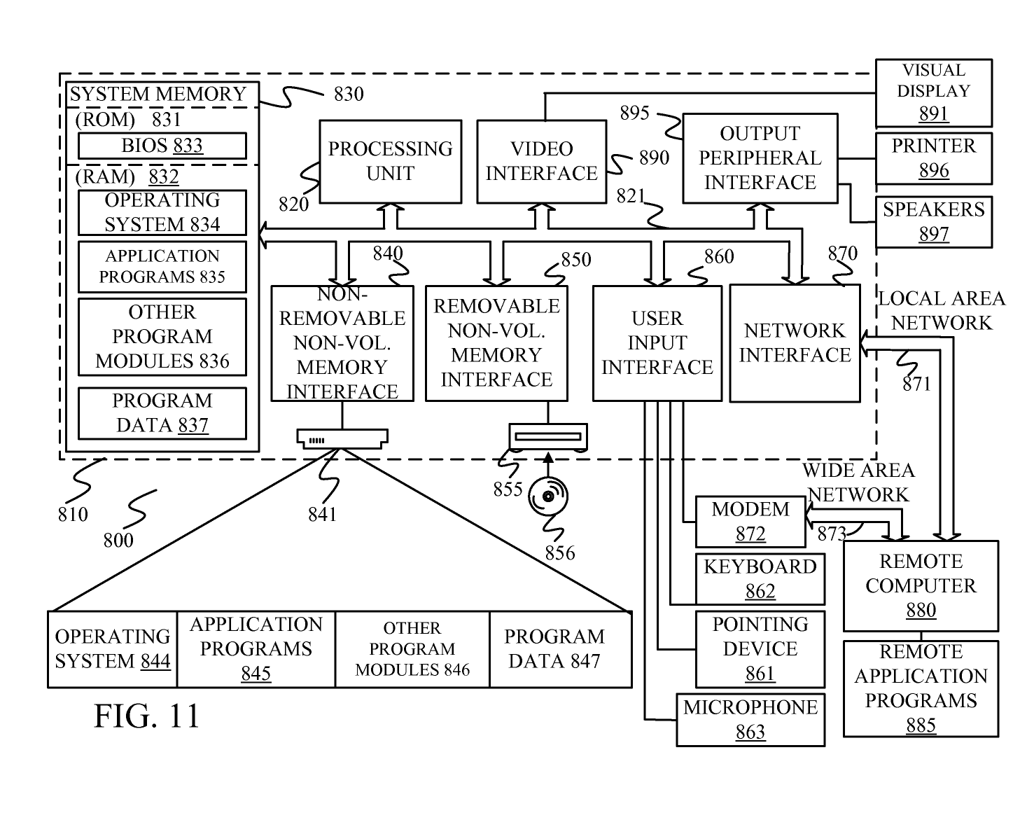

FIG. 11 is one example of a computing environment in which architectures 100 or 300, or parts of them, (for example) can be deployed. With reference to FIG. 11, an example system for implementing some embodiments includes a general-purpose computing device in the form of a computer 810. Components of computer 810 may include, but are not limited to, a processing unit 820 (which can comprise processor 110 or 306), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIGS. 1 and 6 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a user interface component; and

a visualization system, comprising:

a data capturing component that detects user interaction with a category selection user input mechanism, identifying a selected category;

a data store accessing component that accesses a data store, based on the selected category, and identifies subcategories corresponding to the selected category; and

a calendar view generator component that controls the user interface component to surface a calendar user interface display with data capture input mechanisms associated with individual subcategories and individual dates on the calendar user interface display, the data capturing component detecting user interaction with the data capture input mechanisms to capture data and associating the captured data with a given date and a given subcategory.

Example 2 is the computing system of any or all previous examples wherein the data store accessing component accesses the data store and identifies validations corresponding to the subcategories, and further comprising:

a validation component that enforces the validations against data captured by the data capturing component.

Example 3 is the computing system of any or all previous examples wherein the data store accessing component accesses the data store and identifies logic rules corresponding to the category or subcategories, and further comprising:

a calculation component that performs calculations on the data captured by the data capturing component, based on the logic rules, to obtain a result, the calendar view generator component modifying the calendar user interface display by surfacing the result on the calendar user interface display.

Example 4 is the computing system of any or all previous examples wherein the calendar view generator component controls the user interface component to surface the calendar user interface display with a date row that identifies dates and a subcategory column that identifies the subcategories.

Example 5 is the computing system of any or all previous examples wherein the calendar view generator component generates the data capture input mechanisms as editable cells that receive transaction data.

Example 6 is the computing system of any or all previous examples wherein the calendar view generator component generates a subcategory addition user input mechanism that is actuated to add a subcategory to the calendar user interface display.

Example 7 is the computing system of any or all previous examples wherein the user interface component and the visualization component are disposed on a client device and wherein the data store is accessible through a server-based computing system.

Example 8 is a computer-implemented method, comprising:

detecting user interaction with a category selection user input mechanism, identifying a selected category defined in a computing system;

identifying subcategories corresponding to the selected category, in the computing system;

controlling a user interface component to surface a calendar user interface display with data capture input mechanisms associated with individual subcategories and individual dates on the calendar user interface display; and

detecting user interaction with the data capture input mechanisms to capture data and associate the captured data with a given date and a given subcategory, in the computing system.

Example 9 is the computer-implemented method of any or all previous examples and further comprising:

prior to detecting user interaction with the category selection user input mechanism, displaying the category selection user input mechanism and an itemization user input mechanism.

Example 10 is the computer-implemented method of any or all previous examples wherein controlling the user interface component to surface the calendar user interface display comprises:

detecting actuation of the itemization user input mechanism and, in response, displaying the calendar user interface display.

Example 11 is the computer-implemented method of any or all previous examples wherein identifying subcategories comprises:

accessing a data store in the computing system, based on the selected category; and

identifying the subcategories corresponding to the selected category.

Example 12 is the computer-implemented method of any or all previous examples and further comprising:

identifying validations corresponding to the subcategories in the computer system; and

enforcing the validations against captured data.

Example 13 is the computer-implemented method of any or all previous examples and further comprising:

accessing the data store to identify logic rules corresponding to the category or subcategories;

performing calculations on the captured data, based on the logic rules, to obtain a result; and

modifying the calendar user interface display by surfacing the result on the calendar user interface display.

Example 14 is the computer-implemented method of any or all previous examples wherein controlling the user interface component to surface the calendar user interface display comprises:

surfacing the calendar user interface display with a date row that identifies dates and a subcategory column that identifies the subcategories.

Example 15 is the computer-implemented method of any or all previous examples wherein surfacing the data capture input mechanisms comprises displaying a set of editable cells that receive transaction data.

Example 16 is the computing system of any or all previous examples and further comprising:

surfacing the calendar user interface display with a subcategory addition user input mechanism;

detecting actuation of the subcategory addition user input mechanism; and

in response, adding a subcategory to the calendar user interface display.

Example 17 is the computing system of any or all previous examples wherein the user interface component is disposed on a client device and wherein accessing the data store comprises:

accessing the data store at a back end computing system over a network.

Example 18 is a computing system, comprising:

a user interface component; and

a visualization system, comprising:

a data capturing component that detects user interaction with a category selection user input mechanism, identifying a selected category;

a data store accessing component that accesses a data store, based on the selected category, and identifies subcategories and validations, corresponding to the selected category;

a calendar view generator component that controls the user interface component to surface a calendar user interface display with data capture input mechanisms associated with individual subcategories and individual dates on the calendar user interface display, the data capturing component detecting user interaction with the data capture input mechanisms to capture data and associating the captured data with a given date and a given subcategory; and

a validation component that enforces the validations against data captured by the data capturing component.

Example 19 is the computing system of any or all previous examples wherein the data store accessing component accesses the data store and identifies logic rules corresponding to the category or subcategories, and further comprising:

a calculation component that performs calculations on the data captured by the data capturing component, based on the logic rules, to obtain a result, the calendar view generator component modifying the calendar user interface display by surfacing the result on the calendar user interface display.

Example 20 is the computing system of any or all previous examples wherein the calendar view generator component controls the user interface component to surface the calendar user interface display with a date row that identifies dates and a subcategory column that identifies the subcategories, and wherein the calendar view generator component generates the data capture input mechanisms as editable cells that receive transaction data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a user interface component; and
a visualization system, comprising:
a data capturing component that detects user interaction with a category selection user input mechanism, identifying a selected category;
a data store accessing component that accesses a data store, based on the selected category, and identifies subcategories corresponding to the selected category; and
a calendar view generator component that controls the user interface component to surface a calendar user interface display with data capture input mechanisms associated with individual subcategories and time periods on the calendar user interface display, the data capturing component detecting user interaction with the data capture input mechanisms to capture data and associating the captured data with a given time period and a given subcategory.

2. The computing system of claim 1 wherein the data store accessing component accesses the data store and identifies validations corresponding to the subcategories, and further comprising:
a validation component that enforces the validations against data captured by the data capturing component.

3. The computing system of claim 2 wherein the data store accessing component accesses the data store and identifies logic rules corresponding to the category or subcategories, and further comprising:
a calculation component that performs calculations on the data captured by the data capturing component, based on the logic rules, to obtain a result, the calendar view generator component modifying the calendar user interface display by surfacing the result on the calendar user interface display.

4. The computing system of claim 1 wherein the calendar view generator component controls the user interface component to surface the calendar user interface display with a time period row that identifies time periods and a subcategory column that identifies the subcategories.

5. The computing system of claim 4 wherein the calendar view generator component generates the data capture input mechanisms as editable cells that receive transaction data.

6. The computing system of claim 5 wherein the calendar view generator component generates a subcategory addition user input mechanism that is actuated to add a subcategory to the calendar user interface display.

7. The computing system of claim 1 wherein the user interface component and the visualization component are disposed on a client device and wherein the data store is accessible through a server-based computing system.

8. A computer-implemented method, comprising:
detecting user interaction with a category selection user input mechanism, identifying a selected category defined in a computing system;
identifying subcategories corresponding to the selected category, in the computing system;
controlling a user interface component to surface a calendar user interface display with data capture input mechanisms associated with individual subcategories and time periods on the calendar user interface display; and
detecting user interaction with the data capture input mechanisms to capture data and associate the captured data with a given time period and a given subcategory, in the computing system.

9. The computer-implemented method of claim 8 and further comprising:
prior to detecting user interaction with the category selection user input mechanism, displaying the category selection user input mechanism and an itemization user input mechanism.

10. The computer-implemented method of claim 9 wherein controlling the user interface component to surface the calendar user interface display comprises:
detecting actuation of the itemization user input mechanism and, in response, displaying the calendar user interface display.

11. The computer-implemented method of claim 10 wherein identifying subcategories comprises:
accessing a data store in the computing system, based on the selected category; and
identifying the subcategories corresponding to the selected category.

12. The computer-implemented method of claim 11 and further comprising:
identifying validations corresponding to the subcategories in the computer system; and
enforcing the validations against captured data.

13. The computer-implemented method of claim 12 and further comprising:
accessing the data store to identify logic rules corresponding to the category or subcategories;
performing calculations on the captured data, based on the logic rules, to obtain a result; and
modifying the calendar user interface display by surfacing the result on the calendar user interface display.

14. The computer-implemented method of claim 8 wherein controlling the user interface component to surface the calendar user interface display comprises:
surfacing the calendar user interface display with a date row that identifies time periods and a subcategory column that identifies the subcategories.

15. The computer-implemented method of claim 14 wherein surfacing the data capture input mechanisms comprises displaying a set of editable cells that receive transaction data.

16. The computing system of claim 1 and further comprising:
surfacing the calendar user interface display with a subcategory addition user input mechanism;
detecting actuation of the subcategory addition user input mechanism; and
in response, adding a subcategory to the calendar user interface display.

17. The computing system of claim 11 wherein the user interface component is disposed on a client device and wherein accessing the data store comprises:
accessing the data store at a back end computing system over a network.

18. A computing system, comprising:
a user interface component; and
a visualization system, comprising:
a data capturing component that detects user interaction with a category selection user input mechanism, identifying a selected category;
a data store accessing component that accesses a data store, based on the selected category, and identifies subcategories and validations, corresponding to the selected category;
a calendar view generator component that controls the user interface component to surface a calendar user interface display with data capture input mechanisms associated with individual subcategories and time periods on the calendar user interface display, the data capturing component detecting user interaction with the data capture input mechanisms to capture data and associating the captured data with a given time period and a given subcategory; and
a validation component that enforces the validations against data captured by the data capturing component.

19. The computing system of claim 18 wherein the data store accessing component accesses the data store and identifies logic rules corresponding to the category or subcategories, and further comprising:
a calculation component that performs calculations on the data captured by the data capturing component, based on the logic rules, to obtain a result, the calendar view generator component modifying the calendar user interface display by surfacing the result on the calendar user interface display.

20. The computing system of claim 19 wherein the calendar view generator component controls the user interface component to surface the calendar user interface display with a date row that identifies dates and a subcategory column that identifies the subcategories, and wherein the calendar view generator component generates the data capture input mechanisms as editable cells that receive transaction data.
